(19) United States
(12) Patent Application Publication
(10) Pub. No.: US 2019/0317022 A1
(43) Pub. Date: Oct. 17, 2019

(54) SYSTEM AND METHOD OF DETECTING CONTAMINANTS

(71) Applicant: Purdue Research Foundation, West Lafayette, IN (US)

(72) Inventors: Agbai NNANNA, Lafayette, IN (US); Samuel OZEH, West Lafayette, IN (US); Justus NDUKAIFE, West Lafayette, IN (US)

(73) Assignee: Purdue Research Foundation, West Lafayette, IN (US)

(21) Appl. No.: 16/280,802

(22) Filed: Feb. 20, 2019

Related U.S. Application Data
(60) Provisional application No. 62/632,820, filed on Feb. 20, 2018.

(51) Int. Cl. G01N 21/77; G06T 7/90; G06K 9/32; G01N 21/03; G01N 21/17; G06T 7/00

(52) U.S. Cl. CPC G01N 21/77; G06T 7/90; G06K 9/3233; G06F 17/18; G01N 21/17; G06T 7/0002; G01N 21/0303

(57) ABSTRACT

A system including a first container, wherein the first container includes a sample. The system includes a second container, wherein the second container comprises a reagent. Additionally, the system includes a test cell, wherein the test cell is configured to receive the sample and the reagent. Further, the reagent includes at least one of Griess reagent, sulfanilamide, or 1,5-diphenylcarbazide. Moreover, the test cell is situated in a chamber, wherein internal walls of the chamber are white.

### CROSS-REFERENCE TO RELATED APPLICATIONS

The present U.S. patent application is related to and claims the priority benefit of U.S. Provisional Patent Application Ser. No. 62/632,820, filed Feb. 20, 2018, the contents of which is hereby incorporated by reference in its entirety into this disclosure.

### BACKGROUND

Conventional analytical techniques for monitoring the concentration of chemical contaminants in water include Inductively Coupled Plasma-Mass Spectrometry (ICP-MS), Atomic Absorption and Flame Emission Spectrometry and High Performance Liquid Chromatography (HPLC). These techniques are prominent for trace levels detection, analytical versatility and high level of precision. However, there is the need for increased frequency, less complexity and cost effectiveness in the insitu analysis of test water; a need that the standard analytical instruments cannot meet.

### SUMMARY

Efforts have been made by researchers, using the color of the analyte (sample containing target ion+colorimetric reagent) to quantitatively determine the concentration of the target ions so as to overcome the aforementioned challenges. Overtime, the major color spaces that have been considered in the colorimetric target ion characterization are the RGB (Red, Green and Blue) color space and the HSV (Hue Saturation and Value) color space.

The HSV color space is obtained from an algorithm which puts into consideration all the components of the RGB color space. The range of the HSV values are 0≤H≤360, 0≤S≤1 and 0≤V≤1 where H, S and V are sets of real numbers, specific for every distinct color. It has been demonstrated that the undulating Hue value of an analyte with different concentration of a target ion is distinct and of high analytical potential. While there is a good correlation between the concentration and the Hue parameter, no mention was made of the effect of the concentration to the Saturation and Value parameters since they are composite elements to specific colors just as the Hue. Colorimetric fiber optics probe was utilized for the quantitative characterization of chloride, nitrite and hexavalent chromium in the HSV coordinate. It was noted that the fitting parameter (H, S or V) was utilized for the calibration while not accounting for the parameters that do not contribute to the correlation. Additionally, the Saturation parameter (S) of the HSV color space for some analytes were varying more consistently than the Hue value thereby resulting to a calibration using the Saturation for such analyte. In contrast to the distinction between nuances of color in the HSV color space, some calibration based on the color space have been done using only the Hue coordinate while some others have been done using the saturation coordinate. Since specific colors comprise composite and unique HSV parameters, there is need to come up with an algorithm that puts into cognizance, the composite undulations of the HSV parameters as concentration of analytes varies.

Considering the need for real-time quantitative cost effective and user-friendly analytical colorimetric procedures for the evaluation of chemical contaminants in water, this research work seeks to explore the smartphone as a colorimetric analytical tool by developing a smartphone-based contaminant monitoring system for early detection of contaminants in water leveraging on its ubiquity and high analytical prowess. The algorithm utilized in the smartphone calibration addresses the limitation in the colorimetric analytical procedures using the RGB and HSV color spaces within a localized region of interest as highlighted above by the incorporation of a composite relationship between the Hue & Saturation coordinate of the HSV color space within a global region of interest of the analyte. Nitrite and hexavalent Chromium are among some of the chemicals which have been successfully tested.

One aspect of the present application relates to a system including a first container, wherein the first container includes a sample. The system includes a second container, wherein the second container comprises a reagent. Additionally, the system includes a test cell, wherein the test cell is configured to receive the sample and the reagent. Further, the reagent includes at least one of Griess reagent, sulfanilamide, or 1,5-diphenylcarbazide. Moreover, the test cell is situated in a chamber, wherein internal walls of the chamber are white.

Another aspect of the present disclosure includes a system including a first container, wherein the first container includes a sample, wherein the sample includes at least one of nitrite, Chromium (VI), or hexavalent Chromium. The system further includes a second container, wherein the second container includes a reagent. The system also includes a test cell. The test cell is configured to receive the sample and the reagent, and the test cell is made of borosilicate glass. The reagent comprises at least one of Griess reagent, sulfanilamide, or 1,5-diphenylcarbazide. The test cell is situated in a chamber, wherein internal walls of the chamber are white. The chamber includes an LED strip, and the chamber is made of high density polyethylene, wherein the chamber includes an opening.

Still another aspect of the present application includes a method including mixing a sample with a reagent. The reagent includes at least one of Griess reagent, sulfanilamide, or 1,5-diphenylcarbazide, wherein the sample comprises at least one of nitrite, Chromium (VI), or hexavalent Chromium. Additionally, the method includes taking an image, using a camera, of the mixture of the sample with the reagent. The camera is incorporated in a device, wherein the device is a cell-phone. The camera is a 12 megapixel camera. Furthermore, the method includes analyzing the image, wherein the analyzing the image includes analyzing the hue, saturation, and value (HSV) of the image.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1(a) illustrates dynamics of Hue and Saturation with Change in Nitrite ion concentration. FIG. 1(b) illustrates a schematic of a typical color movement within the HSV color wheel.

FIG. 2(a) illustrates a prototype of a smartphone-based contaminant monitoring system. FIG. 2(b) illustrates a test chamber showing the lighting and imaging hole. FIG. 2(c) illustrates a test cell.

FIG. 3(a) illustrates analytes indicating a first region of interest within a cuvette. FIG. 3(b) illustrates analytes indicating a second region of interest. FIG. 3(c) illustrates analytes indicating a third region of interest. FIG. 3(d) illustrates analytes indicating a global region of interest.

FIG. 4(a) illustrates image data as a function of light intensity for standard nitrite analytes (0-3000 ppb). FIG. 4(b) illustrates image data as a function of light intensity for an arbitrary nitrite analyte.

FIG. 5 illustrates hue and saturation values for 9 nitrite analytes analyzed using different region of interest (ROI).

FIG. 6(a) illustrates hue and saturation as a function of concentration for chromium (VI) analytes (0-250 ppb). FIG. 6(b) illustrates hue and saturation as a function of concentration for nitrite analytes (0-3000 ppb). FIG. 6(c) illustrates hue and saturation as a function of concentration for chromium (VI) analyte (0-250 ppb). FIG. 6(d) illustrates hue and saturation as a function of concentration for nitrite analyte (0-3000 ppb).

FIG. 7 illustrates hue and saturation as a function of concentration for nitrite (0-3000 ppb) using different smartphones.

FIG. 8(a) illustrates a flowchat for the smartphone-based contaminant monitoring system. FIG. 8(b) illustrates captured image of analyte. FIG. 8(c) illustrates image of analyte on application interphase showing only the region of interest. FIG. 8(d) illustrates quantitative result obtained from the processed image and safety advice.

### DETAILED DESCRIPTION

The following disclosure provides many different embodiments, or examples, for implementing different features of the present application. Specific examples of components and arrangements are described below to simplify the present disclosure. These are examples and are not intended to be limiting. The making and using of illustrative embodiments are discussed in detail below. It should be appreciated, however, that the disclosure provides many applicable concepts that can be embodied in a wide variety of specific contexts. In at least some embodiments, one or more embodiment(s) detailed herein and/or variations thereof are combinable with one or more embodiment(s) herein and/or variations thereof.

The Hue and the Saturation represents the color and its brilliance respectively, while the Value coordinate gives information of how dark or light an image is. The brightness attenuates as the value tends to zero which connotes a black image. The HSV color space is computed from the intensities of the primary colors obtained from any images as reported in literatures.

$$\begin{matrix}H = \{ \begin{matrix}60 ° \times ( ( \frac{{G}^{′} - {B}^{′}}{Δ} ) mod 6 ) , & {C}_{max} = {R}^{′} \\ 60 ° \times ( ( \frac{{B}^{′} - {R}^{′}}{Δ} ) + 2 ) , & {C}_{max} = {G}^{′} \\ 60 ° \times ( ( \frac{{R}^{′} - {G}^{′}}{Δ} ) + 2 ) , & {C}_{max} = {B}^{′}\end{matrix} & ( 1 ) \\ S = \{ \begin{matrix}0 , & {C}_{max} = 0 \\ \frac{Δ}{{c}_{max}} , & {C}_{max} \neq 0\end{matrix} & ( 2 ) \\ V = {C}_{max} & ( 3 )\end{matrix}$$

where R′=R/255, G′=G/255, B′=B/255, Cₘₐₓ=Max(R′, G′, B′), Cₘᵢₙ=Min(R′, G′, B′), Δ=Cₘₐₓ−Cₘᵢₙ. The values of H and S are function of Cₘₐₓ and Δ. R, G and B in the expressions are the values of the red, green and blue intensities from the RGB color space.

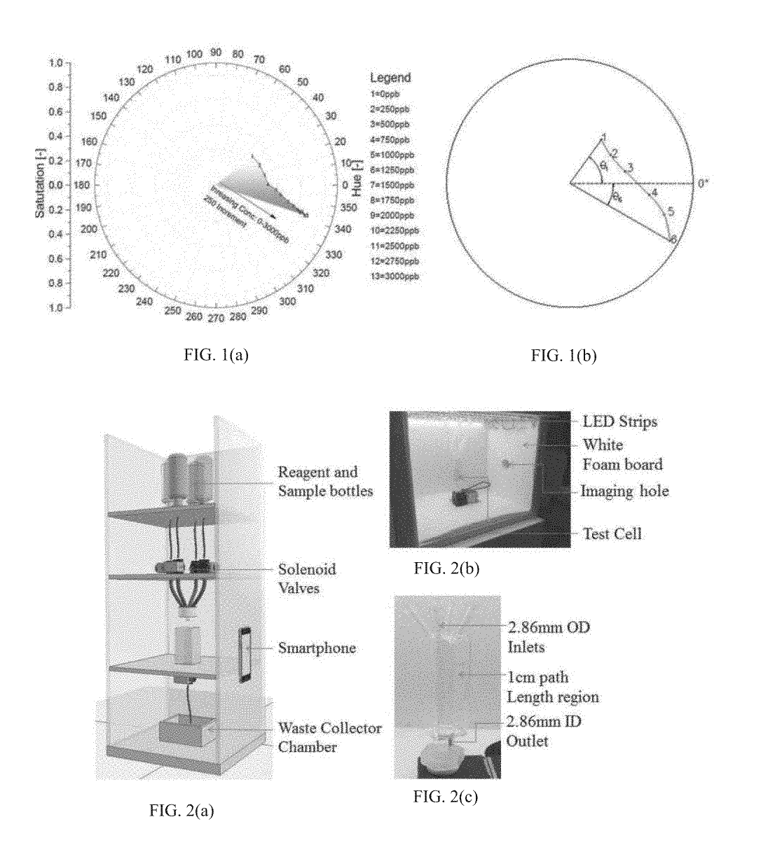

Assuming that the Value coordinate is constant, the cone idealization will reduce to a circle known as the color wheel, with the Hue and Saturation coordinates still being idealized as the angular trajectory and radius of the color respectively. FIG. 1(a) shows the radial plot of the Hue and Saturation parameters of Nitrite analytes ranging from 0 to 3000 ppb. There is a composite variation in both parameters as the concentration of Nitrite varies. There are arrays of saturation parameters that can be associated to a particular Hue parameter. On this note, the colorimetric characterization of the concentration based on a composite parameter which considers the dynamics of the Hue and Saturation within the color wheel will not just map the color of each analyte being considered in the color wheel but will also yield calibrations and results with better specificity.

From circular measures, the area of a sector is a function of the angle and the radius of the sector. This basic relationship has been applied in the colorimetric analysis of target ions using the HSV color space and has been found to be very pivotal to estimating the unknown concentration of a target ion. When the HSV parameter is obtained from image analysis of standard samples of a target ion, mimicking the relationship as in a sector of a circle, the area of such color sector can be obtained where the Hue is the angle of the sector and Saturation coordinate is the radius. Depending on the nature and range of analysis, the variation could be consistent with the Hue value, Saturation value or both as in most cases. Various aspects relates to a systematic algorithm that incorporates the dynamics of constituting coordinate of the HSV color space is developed when used as a quantitative analytical tool. Such algorithm will most definitely produce results that depict the actual trajectory of analyte images with varying concentration of a target ion.

Considering FIG. 1(b), there is a color movement from point 1 to point 6. Assuming that the origin is at 0° from the center of the circle, the area of the sector due to the color at point 1 can be easily obtained as a function of the angular change and the radius at point 1.

$${A}_{1} = \frac{{θ}_{1}}{360} π {r}_{1}^{2} \qquad ( 4 )$$

It should be noted that the angular change, θ₁=H₁ and the radius, r₁=S₁; where H₁ and S₁ are the Hue and Saturation at point 1 respectively. Considering that 360 and π are constants, the equation can be further modified as shown in equation 8.

A₁′=H₁S₁² (5)

Similar progression can be followed for points 2 through to point 6 using the generalized relationship in equation 9.

Aₙ′=HₙSₙ² (6)

where n is the point (or concentration) under consideration within the color wheel. When the HSV parameter is obtained from image analysis of standard samples of a target ion, mimicking the relationship as in a sector of a circle, the area of such color sector can be obtained where the Hue is the angle of the sector and Saturation coordinate is the radius. Depending on the nature and range of analysis, the variation could be consistent with the Hue, Saturation or both.

A plot of the area (HS2) against the concentration within a specified range of concentration for samples of known concentration will yield an empirical relationship that depicts the trajectory of color change with varying concentration of target ion. The empirical relationship can therefore be utilized to evaluate the unknown concentration of a target ion within the range of calibration by simply substituting the value of HS2 and solving for the concentration. The relationship as explained maps out the trajectory within a given range of known concentrations of a target ion on the color wheel, putting into cognizance the undulations in the Hue and Saturation coordinates. Unknown concentration values that are within the calibration range can therefore be obtained from the plot as explained.

The trajectory of the Hue parameter can be such that it decreases from a value greater than 0° to a value less than 0°. For consistency, any such cross movement of the Hue coordinate below 0° will be considered as negative. H₆ will be considered negative due to the clockwise movement of the hue parameter.

Experimental procedures using Nitrite and hexavalent chromium will be demonstrated followed by discussion of the results obtained. Nitrite is a soluble oxyanion that dissolves completely in water thereby not affecting the solution's turbidity. When its concentration in solution is beyond the stipulated value by the Environmental Protection Agency (EPA) and World Health Organization (WHO) (1 mg/L and 3 mg/L respectively), its potential to cause harm increases. Also, hexavalent chromium has a limit of 50 ppb and 100 ppb as stipulated by WHO and EPA respectively, beyond which its propensity to cause harm increases.

Nitrite ion reacts with Griess reagent to yield an azo compound, which is pink in color. Griess reagent is composed of diazotizing reagent, sulfanilamide (SA), which reacts with nitrite in acidic media to form a diazonium salt and N-napthylethylenediamine (NED) which reacts with the diazonium salt (intermediate product) resulting in an azo compound. The equation of the reaction is as shown in (7).

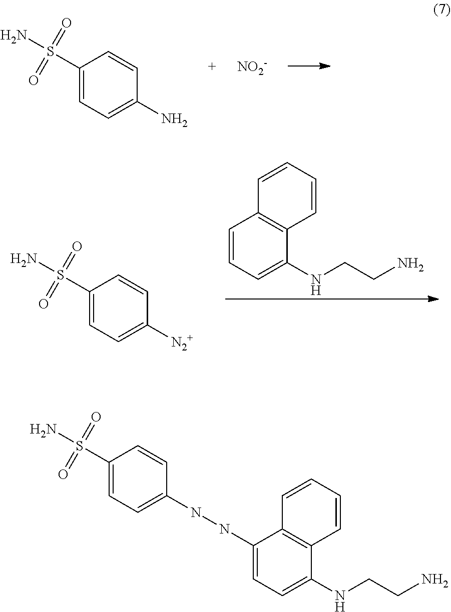

The pink color of the azo compound intensifies with increase in the concentration of Nitrite ion.

Hexavalent chromium ion reacts with 1,5-diphenylcarbazide in acidic medium to form a red-violet colored complex. The composition of the resulting complex is yet unknown. However, the analyte's color intensifies with increase in the concentration of hexavalent chromium ion thereby making the reagent viable for the colorimetric detection of hexavalent chromium.

The colorimetric properties of nitrite and Chromium (VI) analyte will therefore be experimentally observed in the HSV color space considering the composite variations in the Hue and Saturation coordinates within a global region of interest of the test cell. The relationships obtained will subsequently form the basis for the development of a smartphone application, which will be utilized for water quality monitoring against toxic inorganic contaminants.

There exists a variation in the perception of images captured using different brands of smartphones due to one or a combination of the following reasons: Variation in shutter speed, variation in aperture size, variation in lens quality, variation in pixel size and variation in the smartphone's operating system. These variations accounts for the difference in the RGB data distribution obtained from several devices in a constant ambient condition thereby making smartphone calibrations for colorimetric analysis specific to brand and model. However, recalibration can be done if there is a change in smartphone brand/model.

Prototype of the Smartphone-based contaminant monitoring system: The experimental facility consists of a rectangular test chamber with internal dimensions of 185 mm×220 mm×200 mm, width, length and height respectively. The test chamber was fabricated using High Density Polyethylene (HPDE) sheets so as to minimize environmental interference on the optics. The thickness of the HDPE material used for the door and walls is 20 mm while that of the ceiling is approximately 6 mm. The contaminant monitoring system having the smartphone as the core analytical device is presented as shown in FIG. 2(a).

The LED strip and its accessories were purchased from LED Supplies Theale Berkshire, United Kingdom. One meter length of 12 V DC, 9.6 Watts per meter—Super Bright dimmable LED strip which has 120 LED chips per meter was cut into 5 equal lengths (20 cm each) containing 25 LED chips each. The accessories and fitting were used to connect the LEDs to a DC voltage source. The LED strips were placed at a distance of 4 cm apart along the soffit of the light box/test box covering as shown in FIG. 2(b).

White foam board was utilized in padding the internal walls of the test chamber so as to minimize to the barest minimum, the amount of light that will be absorbed. In addition, the white foam board also serves as background for taking images of the complex solution formed. The test cell was fabricated from a borosilicate glass fabricated by Scientific Glass & Plastic Inc. Freeport Tex., USA with a refractive index of 1.473. The path length of the glassware is 1 cm with a wall thickness of 0.9 mm and the four inlets have an outer diameter of 2.86 mm. The outlet has an internal diameter of 2.86 mm and it fits firmly into the hex connector protruding from the solenoid valve.

The smartphone utilized mainly in the research is iPhone SE. The smartphone has a 12 megapixel camera with a f/2.2 aperture and iOS10 operating system. The smartphone application was written using the Xcode so as to be operational with the iPhone. However, the preliminary algorithm was written using MATLAB. The MATLAB script written for the image processing isolates the region of interest (ROI) that is needed for the analysis. Subsequently, the RGB data of the image is processed to obtain its HSV equivalent in accordance with equations 1-3. For calibration purposes, the images of standard analytes are utilized after which the HS² values are plotted against the concentration of target ions. This yields a calibration curve and equation with which an arbitrary analyte's image could be analyzed so as to obtain its corresponding concentration.

Preparation of Standard Solutions and Reagents: A 100 ppm stock solution of hexavalent chromium was prepared by diluting 0.2829 grams of anhydrous potassium dichromate in 1000 ml of deionized water. The serial dilution relationship was used in preparing solutions of hexavalent Chromium ranging from 25 to 250 ppb with intervals of 25.

In preparation of the reagent 1,5diphenyl-carbazide, 0.5 grams of 1,5diphenyl-carbazide powder was measured out into a 250 ml beaker using a chemical balance and spatula. 2 ml of 97% concentrated sulphuric acid was added to the beaker and stirred properly. 200 ml of deionized water was added to the beaker after which the spatula was used to stir further. The mixture is allowed to stand in the beaker till the suspensions settle. With the use of a filter paper, the supernatant is obtained and utilized as the colorimetric reagent for hexavalent chromium.

A 100 ppm stock solution of Nitrite was prepared by diluting 0.1499 grams of anhydrous sodium nitrite in 1000 ml of deionized water. The serial dilution relationship was used in preparing solutions of hexavalent Chromium ranging from 250 to 3000 ppb with intervals of 250. In accordance to the product information sheet from the Griess reagent-modified as purchased from Sigma-Aldrich, 200 ml of deionized water was added to the container of the anhydrous reagent. Mixing was achieved by several inversions of the reagent container after which the reagent is ready to be used. 1 ml of the sample is to be tested with 1 ml of the reagent as instructed in the product information bulletin.

Varying Image data with changes in light Intensity: The nitrite solutions ranging between 0-3000 ppb (increments of 250 ppb) and colorimetric reagents were successively introduced into the test cell in the ratio of 1 ml:1 ml. A waiting period of 15 minutes was observed for the reaction kinetics to be completed before obtaining the image of the analyte. The DC voltage source was utilized for varying the light intensity as measured using the light intensity meter. Each analyte image was obtained at varying light condition ranging from 0-85 Watts/m². The image was processed using a MATLAB script designed to extract the HS² parameter within the region of interest being considered. The plot of HS² value of the analyte's image was obtained as a function of the light intensity.

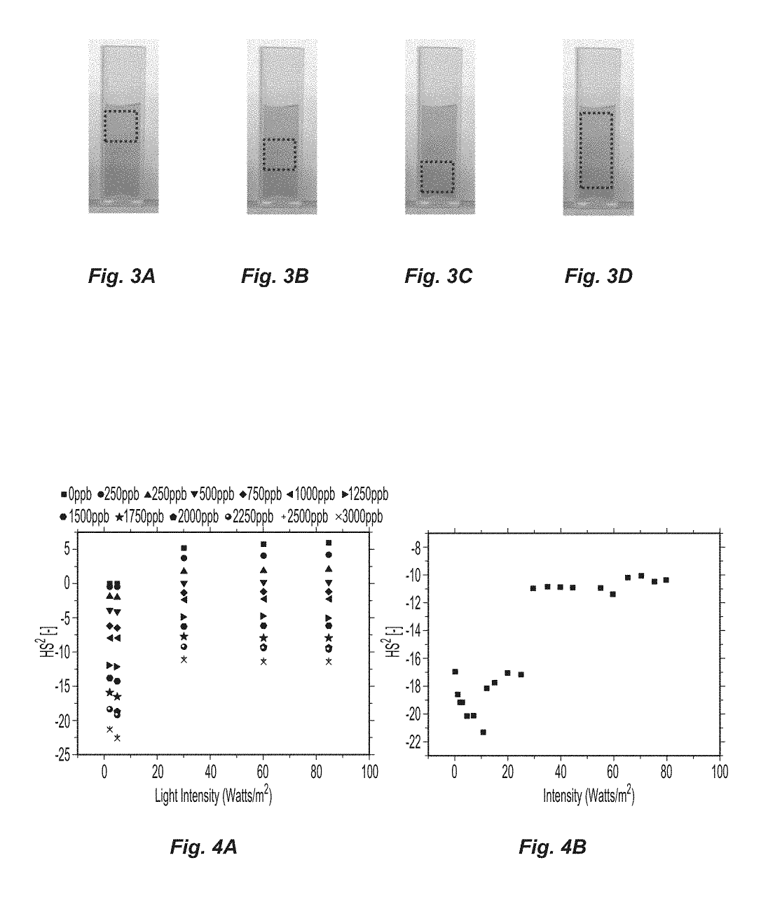

Nine arbitrary analytes are prepared in cuvettes. The images are obtained and analyses are performed based on the regions as shown in FIG. 3(a), FIG. 3(b), FIG. 3(c), and FIG. 3(d). The HS² values obtained for various regions in each analyte is compared in the below paragraphs. This experiment demonstrates the variation in the image data obtained from different smartphone. Additional apparatus used for this experimental procedure are Microsoft Lumia 640 LTE, IPhone SE, Samsung Galaxy J5 and HTC Desire 520. The nitrite solutions and colorimetric reagents were successively introduced into the cuvettes in the ratio of 1 ml:1 ml. Images of Nitrite analytes ranging from 0-3000 ppm (250 ppb increments) were captured using the different brands of smartphone. The HS² is plotted against the corresponding concentration for the different smartphone brands.

An objective of this experiment is to ascertain the patterns of undulation in the Hue, Saturation and HS² parameter of Nitrite and Chromium (VI) analyte as the concentration progressively increase. Also, this generates an empirical relationship and for the determination of Nitrite and Chromium (VI) ion concentration respectively using the Smartphone-based monitoring system within the range of calibration. While the ratio of the solution and reagent was maintained for Nitrite as in previous studies, the Chromium (VI) solutions ranging from 0-250 ppm (25 ppb increments) and colorimetric reagents were successively introduced into the cuvettes in the ratio of 2 ml:1 ml respectively.

The images of the standard analytes were captured at a constant light intensity of 85 Watts/m² through the camera hole in the image chamber of the experimental prototype. Image analysis were performed using the MATLAB script which takes into cognizance, the region of interest and the dynamics of the HSV color space. The variations in Hue, Saturation and HS² with concentration for Nitrite analytes are presented and discussed as shown in the below paragraphs.

Matrix solutions spiked with Nitrite and Chromium (VI) ions were evaluated to deduce the concentration of Nitrite and Chromium (VI) present using the prototype contaminant monitoring system and its algorithm. The samples tested were also sent for analysis to an external laboratory. The results of the analysis are presented and compared in the below paragraphs. Time, economic and human resource analysis are also presented and discussed.

Effect of varying background light intensity on detection sensitivity: The light intensity was varied between 2.5 and 85 watts/m2 for a set of standard nitrite analytes ranging between 0 and 3000 ppb. The HS2 values are as plotted in FIG. 4(a). A single nitrite analyte (3000 ppb) was thereafter examined with closer intervals of light intensity as shown in FIG. 4(b). There is an appreciable change in the HS2 value as the light intensity increases from 0 to 30 Watts/m² after which the HS2 values became somewhat constant between 30 and 85 Watts/m² as depicted in FIG. 4(a) and FIG. 4(b). This result shows that in order to mitigate the influence of background light intensity, experiments should be performed in a conditioned space with light intensity in the range of 30 to 85 Watts/m², in one or more embodiments. Therefore, the calibrations for the smartphone based monitoring system were performed at constant lighting condition in the light chamber, with a light intensity of 85 Watts/m² within the image chamber of the experimental prototype.

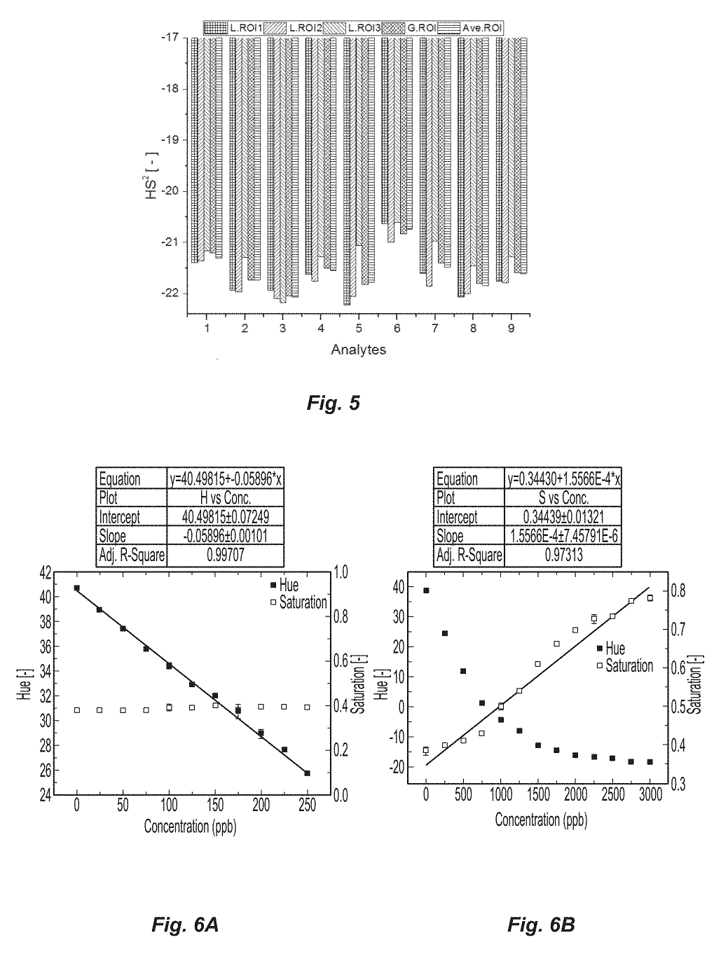

FIG. 5 shows the HS² plot for nine (9) Nitrate analytes analyzed using different region of interests (local, global and average). There are three local ROI for each of the analytes from which the average is obtained. Also, the global region of interest is obtained for each analyte. From the bar chart, it can be deduced that the average value of the local points have the HS² value that consistently approximates most closely to the global region of interest. This shows that evaluating analytes within the global region instead of the local region is more representative of the properties inherent in the complex solution. Hence, a global region of interest wat utilized for calibration of the proposed test system in various embodiments.

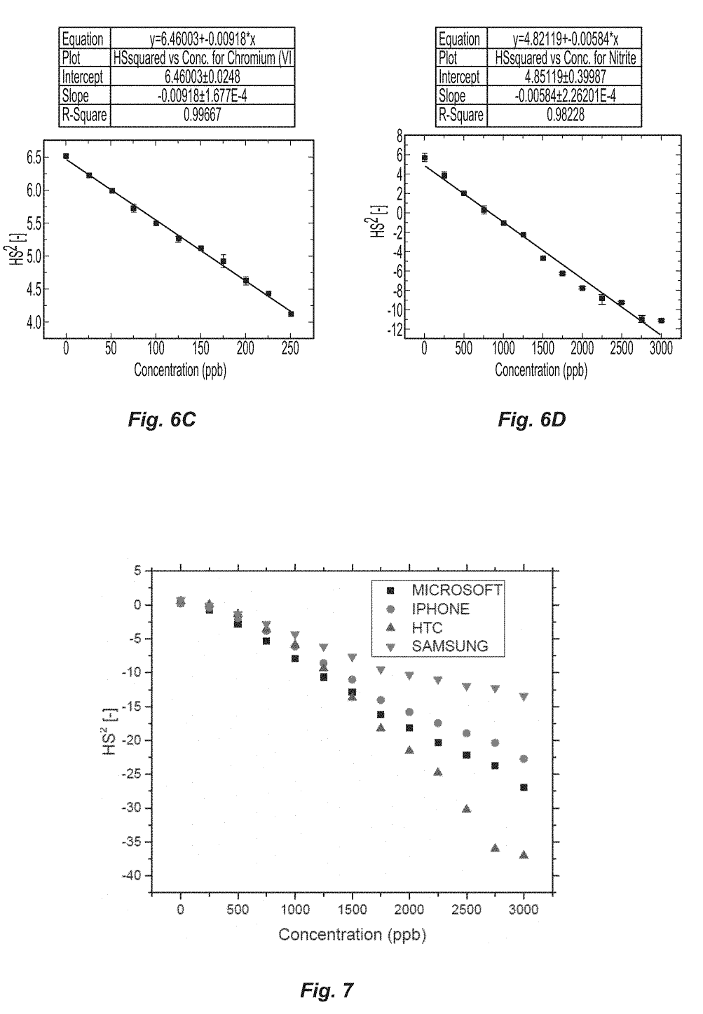

The Hue plot as a function of concentration for chromium (VI) is presented in FIG. 6(a). The trend line of the plot yields a linear relationship with the coefficient of correlation of 0.997. This insinuates that the Hue is sufficient for the development to an empirical relationship for chromium (VI) within the range of concentration being considered (0≤C≤250 ppb). It is also noteworthy that the saturation values for the chromium (VI) analytes within the range of 0≤C≤250 ppb is approximately constant.

The hue and saturation plot for nitrite as a function of concentration is presented in FIG. 6(b). The hue parameter for nitrite steeply deceases as concentration increases from 0 to 1750 ppb. Between 2000 and 3000 ppb, the Hue approximates to asymptotic value. At a constant Saturation, the Hue will be sufficient for the evaluation of the nitrite concentration between 0≤C≤1000 ppb as the slope within the range is constant. However, between 1000≤C≤3000 ppb, the slope and of the hue as a function of concentration tends towards zero thereby making the Hue parameter alone insufficient for the development of an empirical correlation for the full range (0≤C≤3000) of concentration being considered.

A linear correlation was obtained for the saturation as a function of nitrite concentration within the range 0≤C≤3000 ppb and with a coefficient of correlation R=0.973. This therefore informs that at a constant hue value, the correlation obtained from the plot of saturation against the concentration is sufficient in the quantitatively characterization of nitrite ions in water within the range of concentration being considered.

It has been established from the Hue and Saturation plot of Nitrite analyte that none of the parameters is sufficient to define the trajectory of the nitrite analyte within the range of calibration since both parameters were varying. Considering the trajectory of the nitrite analyte within the color wheel in FIG. 1(a), the hue and the saturation are observed to be changing compositely as the concentration changes. Although the Hue parameter of Chromium (VI) appears to be sufficient for its calibration since the Saturation parameter is fairly constant, it is worthwhile utilizing the HS² algorithm as established in section 2 (Theoretical Consideration). This is so as to utilize an algorithm that accounts for the composite undulation in the hue and saturation values, which is robust and can be applicable to other chemical contaminants using the smartphone based monitoring system.

The consistency in the variation of the HS² parameter with changes in concentration has been established in section 2 (Theoretical Consideration). FIGS. 6 (c) and (d) depict the plot of the HS² as a function of the concentration for Chromium (VI) analytes and Nitrite respectively. The light intensity at the time of image capturing was maintained constant at 85 Watts/m² and a global region of interest was considered during the image processing. It is also noteworthy that IPhone SE was utilized for the calibration. The plot yields a linear empirical relationship (HS²)=4.85119−0.00584C with a coefficient of correlation, R²=0.9823 for Nitrite between 0-3000 ppb. Similarly, the HS² varied linearly with the concentration of Chromium (VI). The plot yields a linear empirical relationship (HS²)=6.46003−0.00918C with a coefficient of correlation, R²=0.997. These empirical relationships obtained from Nitrite and Chromium (VI) calibration is utilized as the calibration equation for the determination of arbitrary concentration of Nitrite Chromium (VI) using the Smartphone application.

FIG. 7 depicts the plot of HS² as a function of concentration using different smartphone. It is evident that the pattern of variation is consistent in individual smartphones. However, the perceptions of colors by the four devices are uniquely different. Within the range of concentration 0≤C≤1000 ppb, the standard deviation is approximately 1.2 and below, suggesting a negligible effect of the smartphone brand. This can be attributed to the fact that the color of the analytes within the concentration less than 1000 ppb are not very intense as to obviously bring to bear, the disparity in the smartphone configurations, operating systems and optical capabilities. However, at concentration 1000≤C≤3000 ppb, there is an obvious divergence in the HS² values across brands of smartphone as the concentration increases as evident in the increasing standard deviation in table 1 below.

TABLE 1
HS² as a function of concentration for Nitrite (0-3000
ppb) showing the standard deviation for the smartphones

| Conc | HS² | | | | Std |
|---|---|---|---|---|---|
| (ppb) | M. SOFT | IPHONE | HTC | SAMSUNG | dev |
| 0 | 0.248 | 0.199 | 0.580 | 0.735 | 0.225 |
| 250 | −0.720 | −0.408 | 0.077 | −0.113 | 0.302 |
| 500 | −2.827 | −1.915 | −1.342 | −1.340 | 0.607 |
| 750 | −5.328 | −3.836 | −3.618 | −2.794 | 0.915 |
| 1000 | −7.884 | −6.131 | −5.894 | −4.327 | 1.261 |
| 1250 | −10.636 | −8.592 | −9.377 | −6.137 | 1.642 |
| 1500 | −12.847 | −11.016 | −13.719 | −7.648 | 2.327 |
| 1750 | −16.171 | −14.037 | −18.223 | −9.492 | 3.238 |
| 2000 | −18.134 | −15.812 | −21.539 | −10.312 | 4.087 |
| 2250 | −20.294 | −17.451 | −24.784 | −10.979 | 5.008 |
| 2500 | −22.161 | −18.946 | −30.224 | −11.945 | 6.567 |
| 2750 | −23.710 | −20.355 | −36.010 | −12.264 | 8.544 |
| 3000 | −26.933 | −22.723 | −37.008 | −13.435 | 8.468 |

This therefore informs the need for recalibration if the smartphone utilized in the smartphone based monitoring device needs to be changed.

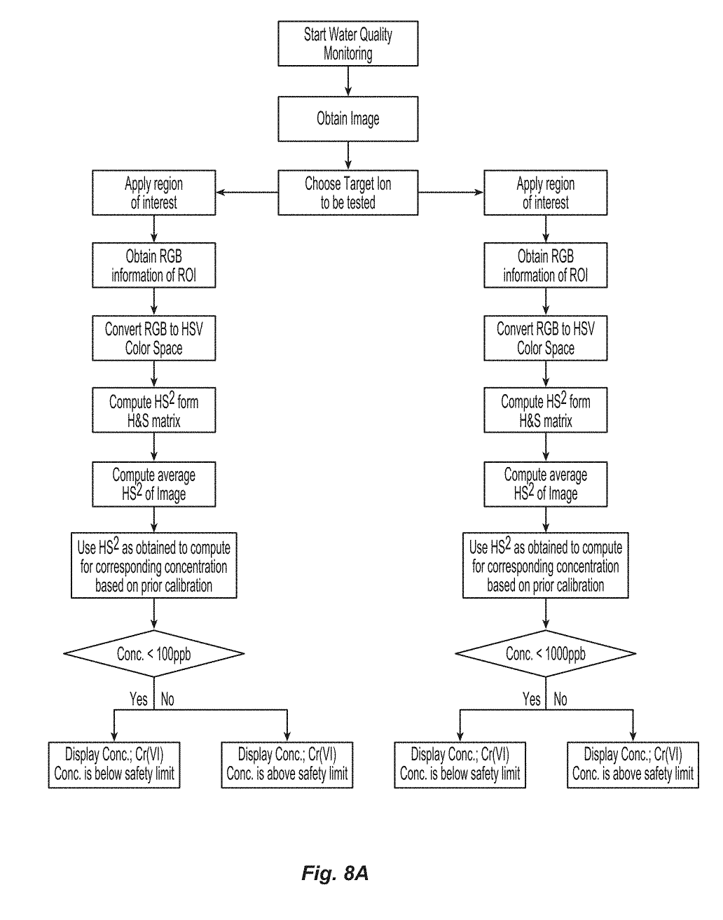

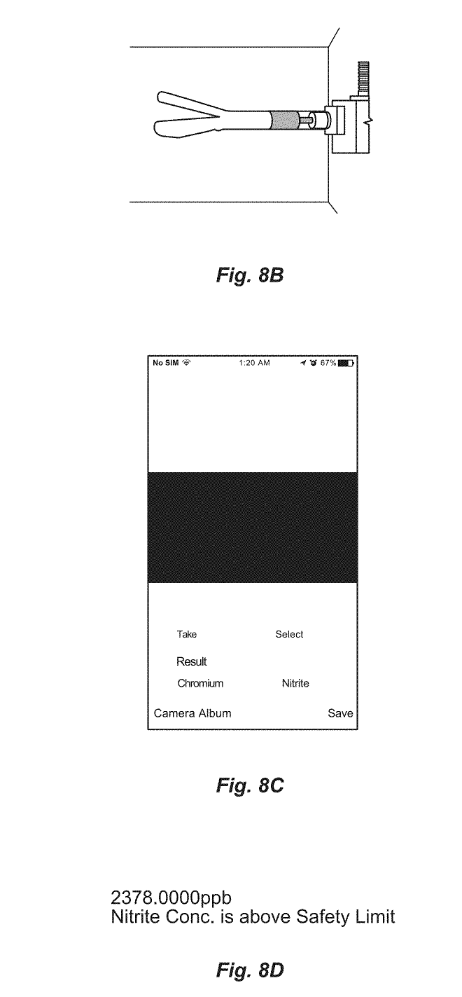

The smartphone application follows the flowchart depicted in FIG. 8(a), utilizing the calibration equations generated for Nitrite and Chromium (VI). FIG. 8(b)-FIG. 8(d) shows the basic functionality of the smartphone application. The image of the analyte is captured as depicted in FIG. 8(b). The algorithm within the smartphone application crops the captured image so that the wall effect is eliminated. Afterwards, the equation which has been pre-installed is utilized in the calculation of the concentration depending on the target ion being analyzed for, and following the flowchart in FIG. 8(a). The result displays on the screen of the smartphone as shown in FIG. 8(d), indicating the safety condition of the water with respect to the target ion's maximum contamination level (MCL) as prescribed by United States Environmental Protection Agency (USEPA).

Using the Smartphone phone based device for chemical contamination monitoring, experiments were conducted to quantitatively ascertain the concentration of Nitrite and Chromium (VI) in several water samples containing arbitrary concentration of target ions. Also, the samples were sent to standard analytical laboratories so as to compare the results obtained. Table 2 presents the results of the analysis

TABLE 2
Results of analysis obtained from Smartphone based colorimetry
in comparison to standard analytical technique

| | | Concentration (ppb) | | |
|---|---|---|---|---|
| | | | Std. | % |
| Sample ID | Ion tested | Smartphone | Analysis | Deviation |
| D | Hex Chromium | 125.68 | 130 | 3.32 |
| | | 140.67 | | −8.21 |
| | Nitrogen (Nitrite) | 806.7 | 850 | 5.09 |
| | | 812.44 | | 4.42 |
| G | Nitrogen (Nitrite) | 700.5 | 700 | −0.07 |
| | | 722.6 | | −3.23 |
| H | Hex Chromium | 138.83 | 150 | 7.45 |
| | | 148.26 | | 1.16 |

From the result as presented in table 2, the highest absolute percentage deviation obtained from comparing the smartphone based monitoring device as proposed with the standard analytical procedure is 8.21%.

The procedure as demonstrated above utilizes simple color analysis and algorithm for the development of a smartphone-based contaminant monitoring system. This Smartphone based contaminant monitoring system comprising an application which is used to obtain the concentration of target ions with a tolerable degree of accuracy when compared to the results from standard procedures such as spectrometry.

### Example 1

A method of detecting a sample includes: mixing a sample with a reagent, wherein the reagent includes at least one of Griess reagent, sulfanilamide, or 1,5-diphenylcarbazide. The sample includes at least one of nitrite, Chromium (VI), or hexavalent Chromium. The method additionally includes taking an image, using a camera, of the mixture of the sample with the reagent, wherein the camera is incorporated in a device. The device is a cell-phone, wherein the camera is a 12 megapixel camera. Further, the method includes analyzing the image. The analyzing the image comprises analyzing the hue, saturation, and value (HSV) of the image. In some embodiments, the camera comprises a f/2.2 aperture. In one or more embodiments, a ratio by volume of the sample to the reagent is 2, wherein the reagent is 1,5-diphenylcarbazide. In at least one embodiment, a ratio by volume of the sample to the reagent ranges from 0.5 to 1.5, wherein the reagent is the Griess reagent. In some embodiments, a ratio by volume of the sample to the reagent ranges from 1 to 2.5, wherein the reagent is 1,5-diphenylcarbazide. In some embodiments, a ratio by volume of the sample to the reagent is 1, wherein the reagent is Griess reagent.

One of ordinary skill in the art would recognize that operations are added or removed from the above method, in one or more embodiments. One of ordinary skill in the art would also recognize that an order of operations in above method is able to be changed, in some embodiments.

### Example 2

A system for detecting sample includes: a first container, wherein the first container includes a sample. The sample includes at least one of nitrite, Chromium (VI), or hexavalent Chromium. The system also includes a second container, wherein the second container includes a reagent. Further, the system includes a test cell, wherein the test cell is configured to receive the sample and the reagent. The test cell is made of borosilicate glass. The reagent comprises at least one of Griess reagent, sulfanilamide, or 1,5-diphenylcarbazide. The test cell is situated in a chamber, wherein internal walls of the chamber are white. The chamber comprises an LED strip, wherein the chamber is made of high density polyethylene. The chamber includes an opening.

The system further includes a camera, wherein the camera is configured to take an image of the test cell via the opening. In some embodiments, a distance between the camera and the test cell ranges from 100 millimeters (mm) to 120 mm. In some embodiments, a ratio by volume of the sample to the reagent is 2, wherein the reagent is 1,5-diphenylcarbazide. In one or more embodiments, a ratio by volume of the sample to the reagent ranges from 0.5 to 1.5, wherein the reagent is the Griess reagent. In at least one embodiment, a ratio by volume of the sample to the reagent ranges from 1 to 2.5, wherein the reagent is 1,5-diphenylcarbazide. In various embodiments, a ratio by volume of the sample to the reagent is 1, wherein the reagent is Griess reagent.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method comprising:
mixing a sample with a reagent, wherein the reagent comprises at least one of Griess reagent, sulfanilamide, or 1,5-diphenylcarbazide;
taking an image, using a camera, of the mixture of the sample with the reagent; and
analyzing the image.

2. The method of claim 1, wherein the analyzing the image comprises analyzing the hue, saturation, and value (HSV) of the image.

3. The method of claim 1, wherein the sample comprises at least one of nitrite, Chromium (VI), or hexavalent Chromium.

4. The method of claim 1, wherein the camera is incorporated in a device, wherein the device is a cell-phone.

5. The method of claim 1, wherein the camera is a 12 megapixel camera.

6. The method of claim 1, wherein the camera comprises a f/2.2 aperture.

7. The method of claim 1, wherein a ratio by volume of the sample to the reagent is 2, wherein the reagent is 1,5-diphenylcarbazide.

8. The method of claim 1, wherein a ratio by volume of the sample to the reagent ranges from 0.5 to 1.5, wherein the reagent is the Griess reagent.

9. The method of claim 1, wherein a ratio by volume of the sample to the reagent ranges from 1 to 2.5, wherein the reagent is 1,5-diphenylcarbazide.

10. The method of claim 1, wherein a ratio by volume of the sample to the reagent is 1, wherein the reagent is Griess reagent.

11. A method comprising:
mixing a sample with a reagent, wherein the reagent comprises at least one of Griess reagent, sulfanilamide, or 1,5-diphenylcarbazide, wherein the sample comprises at least one of nitrite, Chromium (VI), or hexavalent Chromium;
taking an image, using a camera, of the mixture of the sample with the reagent, wherein the camera is incorporated in a device, wherein the device is a cell-phone, wherein the camera is a 12 megapixel camera; and
analyzing the image, wherein the analyzing the image comprises analyzing the hue, saturation, and value (HSV) of the image.

12. The method of claim 11, wherein the camera comprises a f/2.2 aperture.

13. The method of claim 11, wherein a ratio by volume of the sample to the reagent is 2, wherein the reagent is 1,5-diphenylcarbazide.

14. The method of claim 11, wherein a ratio by volume of the sample to the reagent ranges from 0.5 to 1.5, wherein the reagent is the Griess reagent.

15. The method of claim 11, wherein a ratio by volume of the sample to the reagent ranges from 1 to 2.5, wherein the reagent is 1,5-diphenylcarbazide.

16. The method of claim 11, wherein a ratio by volume of the sample to the reagent is 1, wherein the reagent is Griess reagent.

17. A system comprising:
a first container, wherein the first container comprises a sample, wherein the sample comprises at least one of nitrite, Chromium (VI), or hexavalent Chromium;
a second container, wherein the second container comprises a reagent; and
a test cell, wherein the test cell is configured to receive the sample and the reagent, wherein the test cell is made of borosilicate glass,
wherein the reagent comprises at least one of Griess reagent, sulfanilamide, or 1,5-diphenylcarbazide,
wherein the test cell is situated in a chamber, wherein internal walls of the chamber are white, wherein the chamber comprises an LED strip, wherein the chamber is made of high density polyethylene, wherein the chamber comprises an opening.

18. The system of claim 17, further comprising a camera, wherein the camera is configured to take an image of the test cell via the opening.

19. The system of claim 18, wherein a distance between the camera and the test cell ranges from 100 millimeters (mm) to 120 mm.

20. The system of claim 17, wherein a ratio by volume of the sample to the reagent is 2, wherein the reagent is 1,5-diphenylcarbazide.
